(19) United States
(12) Patent Application Publication
(10) Pub. No.: US 2015/0184553 A1
(43) Pub. Date: Jul. 2, 2015

(54) CONTROLLING APPARATUS AND STARTING METHOD

(71) Applicant: KABUSHIKI KAISHA TOSHIBA, Minato-ku (JP)

(72) Inventors: Sayaka AKIYAMA, Yokohama (JP); Masayuki TOBO, Kawasaki (JP); Keiko SHIMIZU, Kawasaki (JP)

(73) Assignee: KABUSHIKI KAISHA TOSHIBA, Minato-ku (JP)

(21) Appl. No.: 14/574,560

(22) Filed: Dec. 18, 2014

(30) Foreign Application Priority Data
Dec. 26, 2013 (JP) 2013-270016

(51) Int. Cl. F01K 23/10; F02C 7/26

(52) U.S. Cl. CPC F01K 23/101; F02C 7/26; F05D 2220/32; F05D 2220/72; F05D 2270/13; F05D 2270/702

(57) ABSTRACT

According to one embodiment, a controlling apparatus is a controlling apparatus to control a combined cycle power plant that includes at least a plurality of units, each of the units including a gas turbine; an heat recovering steam generator that recovers heat of exhaust gas from the gas turbine and generates steam from an incorporated drum; and a turbine bypass regulating valve that sends the steam generated from the drum while keeping a predetermined pressure, and comprises a steam header unit that merges together the steam generated from a plurality of the drums; and a steam turbine to which the steam in the steam header unit is supplied. The controlling apparatus comprising a controlling unit that controls a plurality of the turbine bypass regulating valves based on a steam pressure detected in the steam header unit when the plurality of the units are linked.

### CROSS-REFERENCE TO RELATED APPLICATIONS

This application is based upon and claims the benefit of priority from Japanese Patent Application No. 2013-270016, filed Dec. 26, 2013; the entire contents of which are incorporated herein by reference.

### FIELD

Embodiments described herein relate generally to a controlling apparatus and a starting method.

### BACKGROUND

Combined cycle power plants that are configured by the combination of a gas turbine plant, a steam turbine plant and an heat recovering steam generator are known. As a configuration example of one of them, a so-called 2-2-1 combined cycle power plant is known. The scheme is called 2-2-1 (two-two-one) from the combination of two gas turbines, two heat recovering steam generators and one steam turbine.

The 2-2-1 combined cycle power plant in the conventional technique is started in the order of the starting of a preceding first unit, the passing of steam to the steam turbine and the starting of a subsequent second unit. The series of starting requires a long time, and any delay in this starting is a great disadvantage particularly in tight power supply and demand conditions, for example.

To avoid the problem, that is, for shortening the time for the starting of the combined cycle power plant, it is considered to propose that, at the time of the starting of the 2-2-1 combined cycle power plant, the passing of the steam begin in a state in which the first unit and the second unit are linked. However, in the state in which the first unit and the second unit are linked, interference disadvantageously occurs between the pressure controls of a turbine bypass regulating valve of the first unit and a turbine bypass regulating valve of the second unit, resulting in unstable pressure controls of the turbine bypass regulating valves of both units.

### BRIEF DESCRIPTION OF THE DRAWINGS

FIG. 1 is a schematic configuration diagram of a combined cycle power plant according to the embodiment.

FIG. 2 is a schematic block diagram of the controlling unit CON according to the embodiment.

FIG. 3 is a schematic block diagram of the isolation valve controlling unit 63 according to the embodiment.

FIG. 4 is a schematic block diagram of the passing-of-steam possibility determining unit 70 according to the embodiment.

FIG. 5 is a schematic configuration diagram of a 2-2-1 combined cycle power plant and a controlling apparatus according to the comparative example.

### DETAILED DESCRIPTION

According to one embodiment, a controlling apparatus is a controlling apparatus to control a combined cycle power plant that includes at least a plurality of units, each of the units including a gas turbine; an heat recovering steam generator that recovers heat of exhaust gas from the gas turbine and generates steam from an incorporated drum; and a turbine bypass regulating valve that sends the steam generated from the drum while keeping a predetermined pressure, and comprises a steam header unit that merges together the steam generated from a plurality of the drums; and a steam turbine to which the steam in the steam header unit is supplied. The controlling apparatus comprising a controlling unit that controls a plurality of the turbine bypass regulating valves based on a steam pressure detected in the steam header unit when the plurality of the units are linked.

### Comparative Example

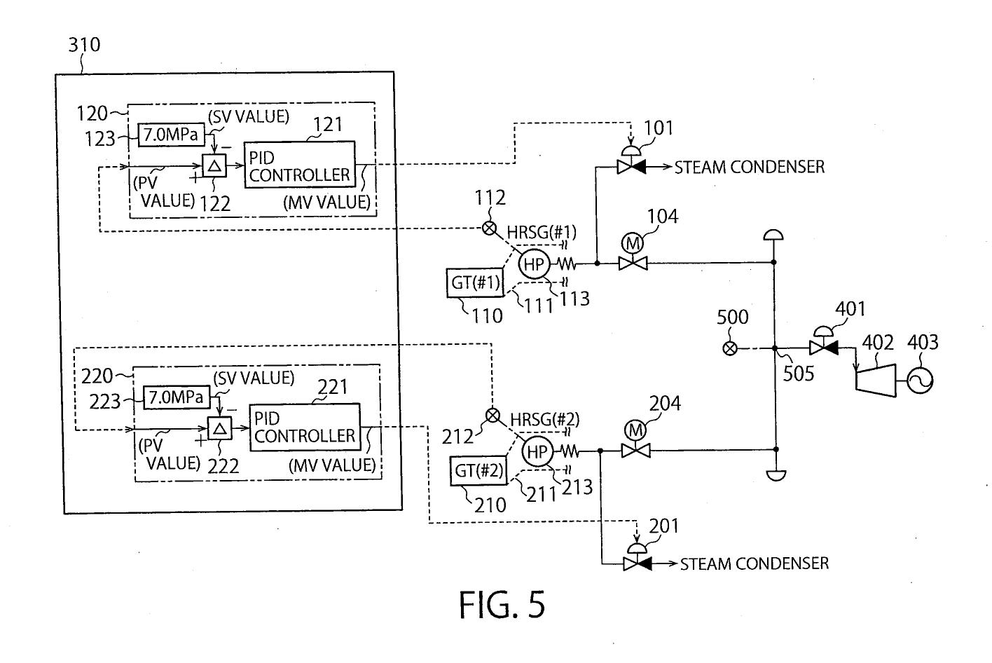

For describing an embodiment of the present invention, a 2-2-1 combined cycle power plant according to a comparative example will first be described. FIG. 5 is a schematic configuration diagram of a 2-2-1 combined cycle power plant and a controlling apparatus according to the comparative example. FIG. 5 shows a state in which a passing of steam described later is being performed. Here, in FIG. 5, ΔΔ represents a state in which a relevant valve is fully opened, ▴▴ represents a state in which the valve is fully closed, and Δ▴ represents a state in which the valve has an intermediate opening degree.

For the sake of convenience, a plant including a #1 gas turbine 110 and a #1 heat recovering steam generator 111, which is one of two configurations of the 2-2-1, is collectively referred to as a first unit (#1 unit). Further, the other plant including a #2 gas turbine 210 and a #2 heat recovering steam generator 211 is collectively referred to as a second unit (#2 unit). In FIG. 5, a steam turbine 402 and a power generator 403 are illustrated. These are common equipment to the #1 unit and the #2 unit, and do not belong to the #1 unit or the #2 unit.

In the starting of the 2-2-1 scheme according to the comparative example in FIG. 5, firstly (precedently), the #1 unit is started, and by the steam generated by the #1 unit, the steam turbine 402 is started. Thereafter (subsequently), the #2 unit is started. More specifically, before the preceding #1 gas turbine 110 and the #1 heat recovering steam generator 111 are started, a #1 isolation valve (shut-off valve) 104 is put into a fully open state. Note that the isolation valve is, for example, a shut-off valve that is a motor-operated valve. A #2 isolation valve (shut-off valve) 204, which is a subsequent valve, is put into a fully closed state, and therefore, the steam generated from the #2 heat recovering steam generator 211 does not flow in the steam turbine 402.

A system configuration state in which the steam generated from the #2 unit is isolated from the #1 unit and the steam turbine 402 in this way is referred to as a #2 isolation state.

When the preceding #1 gas turbine 110 is started, the #1 heat recovering steam generator 111 recovers the heat of the gas turbine exhaust gas, and steam is generated from a #1 drum 113. However, shortly after the starting, the pressure, temperature and flow rate of the steam are insufficient, and it is impossible to open a controlling valve 401 and put the steam in the steam turbine 402 (this is referred to as “passing of steam”). Hence, until the passing of steam becomes possible, the #1 turbine bypass regulating valve 101 acts so as to perform the pressure control over the steam generated from the #1 drum 113 and therewith release it to a steam condenser (not shown).

A first pressure controlling unit 120 of the #1 turbine bypass regulating valve 101 according to the comparative example in FIG. 5 is shown. The first pressure controlling unit 120 illustrated here is a type in which a PID controller 121 and a subtracter 122 are incorporated within the software of a controlling apparatus 310. The PID controller 121, to which a setting value (SV value) and a process value (PV value) are input, calculates a control command value (MV value) by a feedback control such that the PV value is equal to the SV value.

In FIG. 5, the SV value is 7.0 MPa, and the #1 turbine bypass regulating valve 101 performs the pressure control such that the pressure of the #1 drum 113 is kept at 7.0 MPa. Further, the PV value is a pressure value of the #1 drum 113, and concretely, is a value to be measured by a pressure sensor 112. The MV value is output from the PID controller 121 to the #1 turbine bypass regulating valve 101, as a control command to open or close the #1 turbine bypass regulating valve 101. After the starting of the #1 gas turbine 110 in this way, the pressure, temperature and flow rate of the steam increase or rise as time passes, and until these become proper values, the controlling apparatus 310 waits. For example, in the case of the cold starting or the like, the waiting time is about one hour to two hours. Then, when these have risen enough to be in a condition under which the passing of steam is possible, the controlling valve 401 is opened, and the passing of steam to the steam turbine 402 is performed.

The process of the above passing of steam will be described in detail. Firstly, the #1 turbine bypass regulating valve 101 decreases the MV value at a predetermined rate, and fully closes gradually. In this stage, the steam, which was being flowed in the steam condenser, is flowed in the steam header unit 505 and is sent to the controlling valve 401. A controlling unit (not shown) then opens the controlling valve 401 while performing the pressure control such that the pressure of the steam header unit 505 is kept at 7.0 MPa, and the passing of steam begins. Here, the pressure of the steam header unit 505 is measured by a sensor 500. The steam flowed from the controlling valve 401 drives the steam turbine 402, and thereafter, the power generation is performed by the power generator 403, through a parallel operation.

The relation between the pressure value of the steam header unit 505 to be measured by the sensor 500 and the pressure value of the #1 drum 113 to be measured by the pressure sensor 112 is now mentioned. The two have roughly the same pressure value. More precisely, the measured pressure of the sensor 500 is lower than the measured pressure of the pressure sensor 112, by the pipe pressure loss amount. Therefore, the transfer from the pressure control by the #1 turbine bypass regulating valve 101 to the pressure control by the controlling valve 401 described above does not create any problem for the #1 unit and the steam turbine 402, and a stable operation is performed.

On the other hand, the starting of the subsequent #2 unit begins behind the #1 unit. As described above, the #2 unit is in the #2 isolation state in which it is isolated from the steam turbine 402. After the starting of a #2 gas turbine 210, a #2 turbine bypass regulating valve 201 is controlled by a second pressure controlling unit 220, so as to perform the pressure control such that the steam generated from a #2 drum 213 is kept at 7.0 MPa, and therewith to release it to a steam condenser (not shown).

Thereafter, when the #1 turbine bypass regulating valve 101 is fully closed, the valve opening operation of a #2 isolation valve 204 is gradually performed. Simultaneously with this, a #2 turbine bypass regulating valve 201 forcibly decreases the MV value at a predetermined rate, and fully closes gradually. In this stage, a controlling unit (not shown) makes the opening degree of the controlling valve 401 larger, while performing the pressure control such that the pressure of the steam header unit 505 is kept at 7.0 MPa.

The valve opening of the #2 isolation valve 204 from the #2 isolation state in this way and thereby the supply of the steam generated from a #2 heat recovering steam generator 211 to the steam turbine 402 is referred to as a #2 admission.

The 2-2-1 combined cycle power plant according to the comparative example is started in the order of the starting of the preceding first unit, the passing of steam to the steam turbine and the admission of the subsequent second unit. This starting requires a long time, and any delay in the starting is a great disadvantage particularly in tight power supply and demand conditions, for example. The reason for the starting delay is that the “operation of decreasing the MV value of the #1 turbine bypass regulating valve 101 at the predetermined rate and fully closing #1 turbine bypass regulating valve 101 gradually” and the “operation of decreasing the MV value of the #2 turbine bypass regulating valve 201 at the predetermined rate and fully closing #2 turbine bypass regulating valve 201 gradually” are repeated two times in time series.

If the predetermined rate has a great value, a high-speed starting is possible. However, because of a major influence on the #1 drum 113, the #2 drum 213 and the steam turbine 402, this cannot be adopted, and the “operation of fully closing it gradually”, which requires a long time, is necessary. Here, in the case of the above 3-3-1 scheme, this is repeated three times along time series, resulting in a further delayed starting.

In contrast, for shortening the time for the starting of the combined cycle power plant, the embodiment begins the passing of steam in a state in which the #1 unit and the #2 unit are linked, at the time of the starting of the 2-2-1 combined cycle power plant. That is, in a state in which both of the #1 isolation valve 104 and the #2 isolation valve 204 are fully opened, the passing of steam to the steam turbine 402 is begun with the steam of both of the #1 unit and #2 unit merged in the steam header unit 505.

The adoption of such a method of passing steam allows for a starting of simultaneously advancing the “operation of fully closing the #1 turbine bypass regulating valve 101 gradually” and the “operation of fully closing the #2 turbine bypass regulating valve 201 gradually”, and actualizes an “order of the simultaneous starting of the #1 and #2 units and the passing of steam to the steam turbine 402”. This means that the serial two-time turbine bypass full-closing operation in the comparative example is reduced to a parallel one-time operation, allowing for the shortening of the starting time.

After the starting of the gas turbine, it is necessary to wait for the passing of steam beginning until the pressure, temperature and flow rate of the steam increase or rise and these become proper values. However, as another merit of the starting of performing the passing of steam in the state in which the #1 unit and the #2 unit are linked, particularly for the flow rate, there is a merit in that, since the passing of steam can be performed by the total flow rate of the steam flow rates generated in the two units, the time for rising to a steam flow rate at which the passing of steam is possible is significantly shortened, compared to the comparative example, in which the passing of steam is performed by the steam flow rate generated in one unit.

### Embodiment

Hereinafter, an embodiment of the present invention will be described with reference to the drawings. The embodiment can be applied to not only a 2-2-1 combined cycle power plant but also a 3-3-1 combined cycle power plant in which three gas turbines, three heat recovering steam generators and one steam turbine are combined. Furthermore, the application to an N-N-1 configured by gas turbines and heat recovering steam generators whose numbers are “N” (here, “N” is 3 or more) is also possible. For simplification of the description, the 2-2-1 combined cycle power plant will be described as an example.

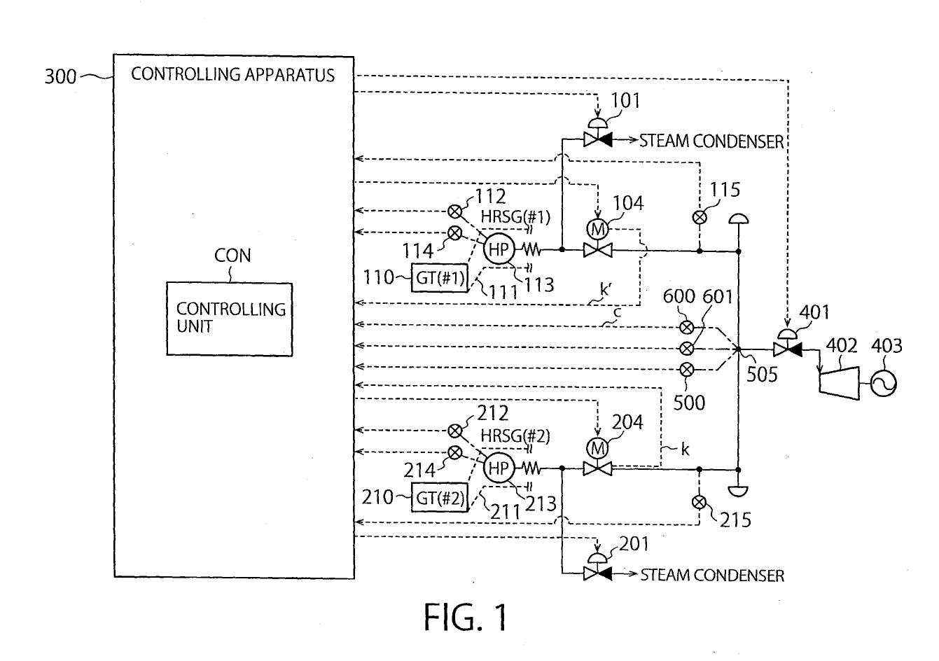

FIG. 1 is a schematic configuration diagram of a combined cycle power plant according to the embodiment. Note that the same elements as those shown in FIG. 5, are denoted by identical reference characters and not specifically described herein. In the configuration of the combined cycle power plant in FIG. 1, a pressure sensor 600 and a temperature sensor 601 are added, compared to the configuration of the combined cycle power plant in FIG. 5. Further, the controlling apparatus 310 is changed into a controlling apparatus 300.

Note that, similarly to the comparative example, in the embodiment, for the sake of convenience, a plant including a #1 gas turbine 110 and a #1 heat recovering steam generator 111, which is one of two configurations of the 2-2-1, is collectively referred to as a #1 unit. Further, the other plant including a #2 gas turbine 210 and a #2 heat recovering steam generator 211 is collectively referred to as a #2 unit. In FIG. 1, a steam turbine 402 and a power generator 403 are illustrated. These are common equipment to the #1 unit and the #2 unit, and do not belong to the #1 unit or the #2 unit.

Similarly to FIG. 5, a steam header unit 505 is provided with a pressure sensor 500. As described above, this is used for the pressure control of a controlling valve 401, and therefore, the embodiment adopts a configuration in which the pressure sensor 600 is newly added, as an example.

Similarly to FIG. 5, the pressure sensor 500 detects the steam pressure value of the steam header unit 505, and supplies a first steam header pressure signal indicating the detected steam pressure value, to the controlling apparatus 300. The pressure sensor 600 detects the steam pressure value of the steam header unit 505, and supplies a second steam header pressure signal indicating the detected steam pressure value “c”, to the controlling apparatus 300. The temperature sensor 601 detects the steam temperature of the steam header unit 505, and supplies a steam header temperature signal indicating the detected steam temperature, to the controlling apparatus 300.

Without proving the pressure sensor 600, the controlling apparatus 300 may use the first steam header pressure signal instead of the second steam header pressure signal, by performing the branching of the first steam header pressure signal output by the pressure sensor 500.

Further, a temperature sensor 114 measures the temperature in the #1 drum 113. Similarly, a temperature sensor 214 measures the temperature in the #2 drum 213.

Furthermore, a flow rate sensor 115 measures the flow rate of the steam to be supplied from the #1 isolation valve 104 to the steam header unit 505. Further, similarly, a flow rate sensor 215 measures the flow rate of the steam to be supplied from the #2 isolation valve 204 to the steam header unit 505.

The controlling apparatus 300 acquires, from the pressure sensor 112, a first turbine pressure signal indicating the pressure detected by the pressure sensor 112, and acquires, from the pressure sensor 212, a second turbine pressure signal indicating the pressure detected by the pressure sensor 212. Further, the controlling apparatus 300 acquires a valve opening signal “k′” indicating the opening/closing of the #1 isolation valve 104, and acquires a valve opening signal “k” indicating the opening/closing of the #2 isolation valve 204.

Moreover, the controlling apparatus 300 acquires, from the temperature sensor 114, a first temperature signal indicating the temperature measured by the temperature sensor 114, and acquires, from the temperature sensor 214, a second temperature signal indicating the temperature measured by the temperature sensor 214. Further, the controlling apparatus 300 acquires, from the flow rate sensor 115, a first flow rate signal indicating the flow rate measured by the flow rate sensor 115. Similarly, the controlling apparatus 300 acquires, from the flow rate sensor 215, a second flow rate signal indicating the flow rate measured by the flow rate sensor 215.

Further, the controlling apparatus 300 acquires, from the sensor 500, a first steam header pressure signal indicating the steam pressure value detected by the sensor 500, and acquires, from the sensor 600, a second steam header pressure signal indicating the steam pressure value “c” detected by the sensor 600. Further, the controlling apparatus 300 acquires, from the sensor 601, a steam header temperature signal indicating the steam temperature detected by the sensor 601.

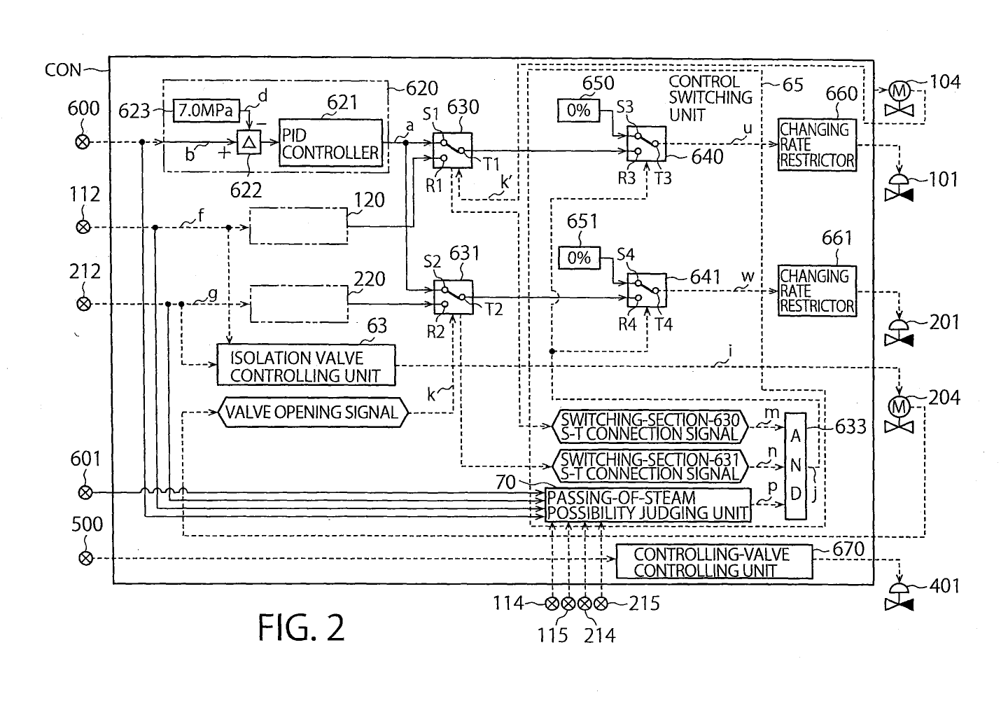

The controlling apparatus 300 controls the #1 turbine bypass regulating valve 101, the #1 isolation valve 104, the #2 turbine bypass regulating valve 201, the #2 isolation valve 204 and the controlling valve 401. The controlling apparatus 300 includes a controlling unit CON. Next, the configuration of the controlling unit CON will be described, using FIG. 2.

FIG. 2 is a schematic block diagram of the controlling unit CON according to the embodiment. Note that the same elements as those shown in FIG. 5, are denoted by identical reference characters and not specifically described herein. The controlling unit CON includes a first pressure controlling unit 120, a second pressure controlling unit 220, a common pressure controlling unit 620, an isolation valve controlling unit 63, a switching unit 630, a switching unit 631, an control switching unit 65, a changing rate restrictor 660, a changing rate restrictor 661 and a controlling-valve controlling unit 670.

The first pressure controlling unit 120 and the second pressure controlling unit 220 are the same as the first pressure controlling unit 120 and the second pressure controlling unit 220 in FIG. 5, respectively, and are not, therefore, described herein.

The common pressure controlling unit 620 is a pressure controlling unit in common between both of the #1 turbine bypass regulating valve 101 and the #2 turbine bypass regulating valve 201.

The common pressure controlling unit 620 includes a PID controller 621 and a subtracter 622.

The subtracter 622 uses, as a PV value “b”, the steam pressure value “c” measured by the sensor 600 that is provided in the steam header unit 505. An SV value “d” is a predetermined value, and in the embodiment, as an example, is 7.0 MPa, similarly to FIG. 5. The subtracter 622 subtracts 7.0 MPa from the PV value “b”, and outputs an after-subtraction signal indicating the value after the subtraction, to the PID controller 621.

Based on the after-subtraction signal, the PID controller 621 calculates an MV value “a” that is a control command value, by a feedback control, such that the PV value “b” is equal to the SV value “d” (7.0 MPa, here). The PID controller 621 outputs an MV-value signal indicating the calculated MV value “a”, to the switching unit 630 and the switching unit 631. The PID controller 621 controls the #1 turbine bypass regulating valve 101 and the #2 turbine bypass regulating valve 201, through the switching unit 630 and the switching unit 631.

Thus, the #1 turbine bypass regulating valve 101 and the #2 turbine bypass regulating valve 201 are controlled based on the identical control command value that is the MV value “a” of the PID controller 621, and therefore, the interference between both turbine bypass regulating valves, which is a problem in the conventional art, does not occur.

Strictly speaking, the pressure of the #1 drum 113 and the steam pressure of the steam header unit 505 are different. The PV value “b” of the PID controller 621 is not the pressure of the #1 drum 113 but the steam pressure of the steam header unit 505. However, since the steam from the #1 drum 113 and the steam from the #2 drum 213 are merged in the steam header unit 505, for example, when the pressure of the #1 drum 113 is decreased for some reason, the pressure of the steam header unit 505 is also decreased. Therefore, the PID controller 621 acts such that the opening degree of the #1 turbine bypass regulating valve 101 is decreased, and works such that the pressure is restored. Accordingly, even when not the pressure of the #1 drum 113 but the steam pressure of the steam header unit 505 is used as the PV value “b” of the PID controller 621, the stable operation of the plant is not hindered at all.

Here, the embodiment is an application to two turbine bypass valves. However, also for an N-N-1 combined cycle power plant configured by gas turbines and heat recovering steam generators whose numbers are “N” (“N” is an integer of 3 or more), it is possible to control the “N” turbine bypass regulating valves, by the branching of the MV value “a” of the PID controller 621.

The switching unit 630 includes a terminal S1 connected with an output of the PID controller 621, a terminal R1 connected with an output of the first pressure controlling unit 120, and a terminal T1. The switching unit 630 switches between a state in which the terminal S1 and the terminal T1 are connected (S-T connection) and a state in which the terminal R1 and the terminal T1 are connected (R-T connection), based on the valve opening signal “k”' input from the #1 isolation valve 104.

Concretely, before the beginning of the starting, the switching unit 630 is in the state in which the terminal R1 and the terminal T1 are connected. At the time of the beginning of the starting, the controlling apparatus 300 controls the #1 isolation valve 104 to be opened. Thereby, when the #1 isolation valve 104 is opened, the switching unit 630, to which a valve opening signal “k” turned ON is input, switches to the state in which the terminal S1 and the terminal T1 are connected (S-T connection). Thereby, the #1 turbine bypass regulating valve 101 is controlled with the MV value “a” of the

PID controller 621.

The switching unit 631 includes a terminal S2 connected with the output of the PID controller 621, a terminal R2 connected with an output of the second pressure controlling unit 220, and a terminal T2. The switching unit 631 switches between a state in which the terminal S2 and the terminal T2 are connected (S-T connection) and a state in which the terminal R2 and the terminal T2 are connected (R-T connection), based on the valve opening signal “k” input from the isolation valve 204.

Concretely, the #2 isolation valve 204 is provided with a limit switch (not shown) to detect that the valve has been opened. The limit switch detects that the #2 isolation valve 204 has been opened, and, when it has been opened, turns ON the valve opening signal “k” to be output to the switching unit 631 of the controlling apparatus. In the case where the #2 isolation valve 204 is not opened, that is, in the case where the valve opening signal “k” is OFF, it is in the state in which the terminal R2 and the terminal T2 are connected (R-T connection). In the case where the #2 isolation valve 204 is opened, that is, in the case where the valve opening signal “k” is ON, the switching unit 631 switches to the state in which the terminal S2 and the terminal T2 are connected (S-T connection). Thereby, the #2 turbine bypass regulating valve 201 is controlled with the MV value “a” of the PID controller 621.

The isolation valve controlling unit 63 controls the #2 isolation valve 204, based on a #1 drum pressure “f” detected by the pressure sensor 112 and a #2 drum pressure “g” detected by the pressure sensor 212. Concretely, for example, the isolation valve controlling unit 63 outputs a valve opening command “i” for commanding the valve opening, to the #2 isolation valve 204, and thereby, opens the #2 isolation valve 204. The detail of the isolation valve controlling unit 63 will be described later.

When the plurality of turbine bypass regulating valves 101, 201 are made to be controlled based on the control command value generated by the common pressure controlling unit 620, by the switching units 630, 631, the control switching unit 65 executes the following. Based on the steam pressure and temperature of the steam header unit 505, and each pressure of the #1 drum 113 and #2 drum 213 included in the respective units, the control switching unit 65 switches the control of the plurality of turbine bypass regulating valves 101, 201 between the control by the forcible valve closing and the control by the common pressure controlling unit 620 or the pressure controlling units 120, 220.

The changing rate restrictor 660 controls the #1 turbine bypass regulating valve 101 such that the #1 turbine bypass regulating valve 101 is closed at a predetermined changing rate “β” for the full closing.

The changing rate restrictor 661 controls the #2 turbine bypass regulating valve 201 such that the #2 turbine bypass regulating valve 201 is closed at a predetermined changing rate “β” for the full closing.

The controlling-valve controlling unit 670 controls the controlling valve 401, based on the steam pressure detected by the pressure sensor 500.

Next, the detail of the configuration of the control switching unit 65 will be described.

The control switching unit 65 includes a passing-of-steam possibility determining unit 70, and an AND gate 633 in which a first input is connected with an output of the switching unit 630, a second input is connected with an output of the switching unit 631 and a third input is connected with an output of the passing-of-steam possibility determining unit 70.

Furthermore, the control switching unit 65 includes a switching unit 640 in which an input is connected with an output of the AND gate 633, and a switching unit 641 in which an input is connected with an output of the AND gate 633.

Moreover, the control switching unit 65 includes a setting device 650 in which an output is connected with a terminal S3 of the switching unit 640, and a setting device 651 in which an output is connected with a terminal S4 of the switching unit 641.

The passing-of-steam possibility determining unit 70 determines whether the passing of steam to the steam turbine 402 is possible. Thereafter, the passing-of-steam possibility determining unit 70 generates a passing-of-steam possibility signal indicating whether the passing of steam is possible, and outputs the generated passing-of-steam possibility signal to the AND gate 633.

The AND gate 633 generates a passing-of-steam beginning command “j” for commanding the beginning of the passing of steam, based on a switching-unit-630 S-T connection signal “m”, a switching-unit-631 S-T connection signal “n”, and the passing-of-steam possibility signal “p” generated by the passing-of-steam possibility determining unit 70. Note that the switching-unit-630 S-T connection signal “m” is a signal that indicates whether the terminal S1 and terminal T1 of the switching unit 630 are connected and that is turned ON when the switching unit 630 is in the S-T connection. Further, the switching-unit-631 S-T connection signal “n” is a signal that indicates whether the terminal S2 and terminal T2 of the switching unit 631 are connected and that is turned ON when the switching unit 630 is in the S-T connection.

Concretely, when all of the switching-unit-630 S-T connection signal “m”, the switching-unit-631 S-T connection signal “n” and the passing-of-steam possibility signal “p” are turned ON, the AND gate 633 turns the passing-of-steam beginning command “j” ON.

In this case, the passing-of-steam beginning command “j” is turned ON when the beginning of the passing-of-steam is commanded, and is turned OFF when the beginning of the passing of steam is not commanded. The AND gate 633 outputs the generated passing-of-steam beginning command “j”, to the switching unit 640 and the switching unit 641.

The setting device 650 keeps 0%, and outputs 0% to the terminal S3 of the switching unit 640.

Further, the setting device 651 keeps 0%, and outputs 0% to the terminal S4 of the switching unit 641.

The switching unit 640 and the switching unit 641 are provided for each unit.

The switching unit 640 includes the terminal S3 connected with the setting device 650, a terminal R3 connected with the terminal T1 of the switching unit 630, and a terminal T3 connected with an input of the changing rate restrictor 660. Based on the result of the determination by the passing-of-steam possibility determining unit 70, the switching unit 640 switches between the control by the forcible valve closing and the control by the common pressure controlling unit 620 or the first pressure controlling unit 120. Concretely, the switching unit 640 switches to a state in which the terminal S3 and the terminal T3 are connected (S-T connection), when the passing-of-steam beginning command “j” is ON, and switches to a state in which the terminal R3 and the terminal T3 are connected (R-T connection), when the passing-of-steam beginning command “j” is OFF.

Therefore, when the passing-of-steam beginning command “j” is ON, 0%, which is set in the setting device 650, is selected as the output “u” of the switching unit 640. The output “u” is input to the changing rate restrictor 660, and the changing rate restrictor 660 controls the #1 turbine bypass regulating valve 101 such that the #1 turbine bypass regulating valve 101 is closed at the predetermined changing rate “β” for the full closing.

The switching unit 641 includes the terminal S4 connected with the setting device 651, a terminal R4 connected with the terminal T2 of the switching unit 631, a terminal T4 connected with an input of the changing rate restrictor 661. Similarly, based on the result of the determination by the passing-of-steam possibility determining unit 70, the switching unit 641 switches between the control by the forcible valve closing and the control by the common pressure controlling unit 620 or the second pressure controlling unit 220. Concretely, the switching unit 641 switches to a state in which the terminal S4 and the terminal T4 are connected (S-T connection), when the passing-of-steam beginning command “j” is ON, and switches to a state in which the terminal R4 and the terminal T4 are connected (R-T connection), when the passing-of-steam beginning command “j” is OFF.

Therefore, when the passing-of-steam beginning command “j” is ON, 0%, which is set in the setting device 651, is selected as the output “w” of the switching unit 641. The output “w” is input to the changing rate restrictor 661, and the changing rate restrictor 661 controls the #2 turbine bypass regulating valve 201 such that the #2 turbine bypass regulating valve 201 is closed at the predetermined changing rate “β” for the full closing.

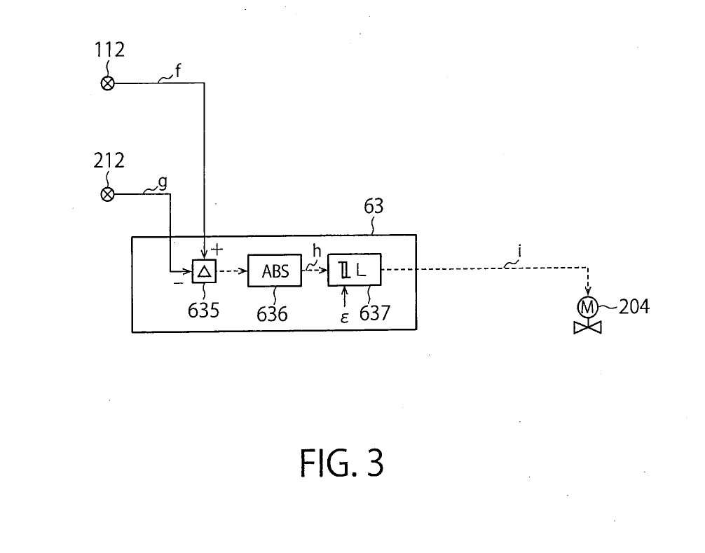

FIG. 3 is a schematic block diagram of the isolation valve controlling unit 63 according to the embodiment.

The isolation valve controlling unit 63 includes a subtracter 635 in which a first input is electrically connected with the pressure sensor 112 and a second input is electrically connected with the pressure sensor 212.

Furthermore, the isolation valve controlling unit 63 includes an absolute value converter 636 in which an input is connected with the output of the subtracter 635, and a comparator 637 in which an input is connected with an output of the absolute value converter 636.

The #1 drum pressure “f” to be used as the PV value of the first pressure controlling unit 120, and the #2 drum pressure “g” to be used as the PV value of the second pressure controlling unit 220 are input to the subtracter 635. The subtracter 635 subtracts the #2 drum pressure “g” from the #1 drum pressure “f”, and outputs the differential value obtained by the subtraction, to the absolute value converter 636. The absolute value converter 636 outputs a pressure deviation “h” that is the absolute value of the differential value, to the comparator 637.

The comparator 637 determines whether the pressure deviation “h” input from the absolute value converter 636 is smaller than or equal to a pressure deviation “ε”, which is sufficiently small. When the pressure deviation “h” is smaller than or equal to the sufficiently small pressure deviation “ε”, the comparator 637 outputs the valve opening command “i” to the #2 isolation valve 204, and the #2 isolation valve 204 is opened.

### Starting Method

In the starting method of the 2-2-1 combined cycle power plant according to the embodiment, the starting of the #1 unit is begun, and the #1 isolation valve 104 is put into the valve closed state. In this state, the pressure controlling unit 120 monitors the drum pressure of the #1 unit, and performs such a control that the generated steam is discarded to the steam condenser through the #1 turbine bypass valve 101 until it has a condition in which the passing of steam is possible. When it has the condition in which the passing of steam is possible, the #1 isolation valve 104 is put into the valve opened state, the #1 turbine bypass valve 101 is gradually closed, and the passing of steam is begun. On this occasion, the #2 isolation valve 204 is kept in the valve closed state (#2 isolation state), and the #1 unit and the #2 unit are simultaneously started.

However, in an actual combined cycle, the gas turbine shortly after the starting requires a torque assist by a starting apparatus such as a cranking electric motor for starting. For reducing the load on the power source (the electric motor supplies high power), a slight time lag is provided between starting of the #1 unit and #2 units, allowing for the avoidance of complete simultaneous starting of the #1 unit and #2 units. In the embodiment, for simplification of the description, this is described as the simultaneous starting. Further, the preceding #1 unit generates steam earlier than the #2 unit, and thereby, an imbalance in steam pressure appears between both drums. Therefore, the #2 unit is started after the #2 isolation valve 204 is closed.

Next, FIG. 2 is a diagram for describing a case where a certain amount of time passes after the #1 unit and the #2 unit are started and the steam flow rate and pressure rise to proper values.

Since the #1 isolation valve 104 is opened, the terminals of the switching unit 630 are in the S-T connection, resulting in the control by the common pressure controlling unit 620. That is, the #1 turbine bypass regulating valve 101 is controlled with the MV value “a” of the PID controller 621. Further, since the #2 isolation valve 204 is closed, the valve opening signal “k” is OFF. The terminals of the switching unit 631 are in the R-T connection, and the #2 turbine bypass regulating valve 201 is controlled by the second pressure controlling unit 220.

When the output of the subsequent #2 gas turbine keeps up with the output of the #1 gas turbine, the #1 drum pressure “f” and the #2 drum pressure “g” becomes roughly equal. When the isolation controlling unit 63 detects that the pressure deviation “h” becomes smaller than the pressure deviation “ε”, the valve opening command “i” for the #2 isolation valve 204 is output, and the valve is opened. When the #2 isolation valve 204 is opened, the valve opening signal “k” is turned ON, and the terminals of the switching unit 631 become in the S-T connection, resulting in the control by the common pressure controlling unit 620. That is, the #2 turbine bypass regulating valve 201 is controlled with the MV value “a” of the PID controller 621.

That is, in the state in which both of the #1 isolation valve 104 and the #2 isolation valve 204 are opened and the #1 unit and the #2 unit are linked, the #1 turbine bypass regulating valve 101 and #2 turbine bypass regulating valve 201 shown in FIG. 1 are controlled based on the identical control command value, which is the MV value “a” of the PID controller 621 of the common pressure controlling unit 620, and the interference between both bypass regulating valves does not occur.

Next, the ensuing starting method of the 2-2-1 combined cycle power plant according to the embodiment, which includes the passing of steam to the steam turbine 402, will be described.

Thereafter, when the thermal energy of the #1 gas turbine 110 and #2 gas turbine 210 is continuously input to the #1 heat recovering steam generator 111 and #2 heat recovering steam generator 211. as time passes, the pressure, temperature and flow rate of the steam increase or rise. The controlling apparatus 300 comprehensively determines that the passing of steam to the steam turbine 402 has become possible, and turns the passing-of-steam possibility signal “p” ON.

Thereby, all of the switching-unit-630 S-T connection signal “m”, the switching-unit-631 S-T connection signal “n”, and the passing-of-steam possibility signal “p” are turned ON, and then, the passing-of-steam beginning command “j” is turned ON by the AND gate 633.

Then, the switching unit 640 switches to the S-T connection, and the output “u” switches from the MV value “a” of the PID controller 621 to 0%, which is set in the setting device 650. FIG. 2 illustrates this state.

Then, the output “u” of the switching unit 640 is decreased to 0% at a rating of the changing rate “β”, by the changing rate restrictor 660, and the #1 turbine bypass regulating valve 101 gradually decreases the opening degree at the rating of the changing rate β, and fully closes.

On the other hand, the #2 turbine bypass regulating valve 201 gradually decreases the opening degree at the rating of the changing rate “β”, and fully closes, by the same action with the switching unit 641, the setting device 651 and the changing rate restrictor 661.

When the opening degrees of both turbine bypass regulating valves are decreased in this way, the steam flowing in the steam condensers until then flows in the steam header unit 505, and is fed to the controlling valve 401. Then, the controlling-valve controlling unit 670 opens the controlling valve 401 while performing the pressure control such that the pressure of the steam header unit 505 is kept at 7.0 MPa, and the passing of steam begins.

Here, at this time, only the controlling valve 401 performs the pressure control. The #1 turbine bypass regulating valve 101 and the #2 turbine bypass regulating valve 201 do not perform the pressure control, and the full closing operation is performed, so to speak, forcibly. Therefore, the problem of the pressure control interference among these three valves does not arise.

Thus, the controlling unit CON begins the starting of the gas turbine in the state in which the #2 isolation valve (shut-off valve) 204 is closed, determines that at least one of the pressure, temperature and flow rate of the steam generated from the drum of the #2 heat recovering steam generator becomes equal to that of the #1 heat recovering steam generator of the precedently started gas turbine, and then executes the process of opening the #2 isolation valve (shut-off valve) 204.

Then, in the state in which all of the plurality of shut-off valves are opened and the plurality of turbine bypass regulating valves are controlled by the common pressure controlling unit 620, the controlling unit CON closes the turbine bypass regulating valves in the respective units simultaneously and gradually, merges all of the steam generated from the plurality of drums in the steam header unit 505, and then performs the passing of steam to the steam turbine 402.

Thereby, in the starting method for the 2-2-1 combined cycle power plant according to the embodiment, for the beginning of the passing of steam, it is possible to simultaneously advance the full closing operation of the #1 turbine bypass regulating valve 101 and the full closing operation of the #2 turbine bypass regulating valve 201 under the control of the common pressure controlling unit 620, in the state in which the #1 unit and the #2 unit are linked. Thereby, the starting procedure is actualized in the order of the simultaneous starting of the #1 unit and the #2 unit, and the passing of steam to the steam turbine 402. That is, the starting method according to the embodiment achieves the procedure reduction and allows for the shortening of the starting time, relative to the conventional-art starting procedure in the order of the starting of the #1 unit, the passing of steam to the steam turbine 402, and the admission of the #2 unit.

The embodiment is an application to two turbine bypass valves. However, a 3-3-1 combined cycle power plant configured by three gas turbines and three heat recovering steam generators also can be started in a similar procedure. That is, the #1 unit and the #2 unit are linked and become in the above state. Thereafter, when the gas turbine of a last started #3 unit keeps up with the gas turbine outputs of the #1 unit and the #2 unit, a #3 isolation valve is similarly opened, and a #3 turbine bypass regulating valve is switched to the control with the MV value “a” of the PID controller 621. As easily understood, by repeating this procedure, the application to an N-N-1 combined cycle power plant configured by gas turbines and heat recovering steam generators whose numbers are “N” is also possible.

Further, although the embodiment is an application to two turbine bypass valves, an N-N-1 combined cycle power plant configured by gas turbines and heat recovering steam generators whose numbers are “N” also can begin the passing of steam while simultaneously performing the full closing operations of all the “N” turbine bypass regulating valves, from a state in which the “N” turbine bypass regulating valves are controlled with the MV value “a” of the PID controller 621.

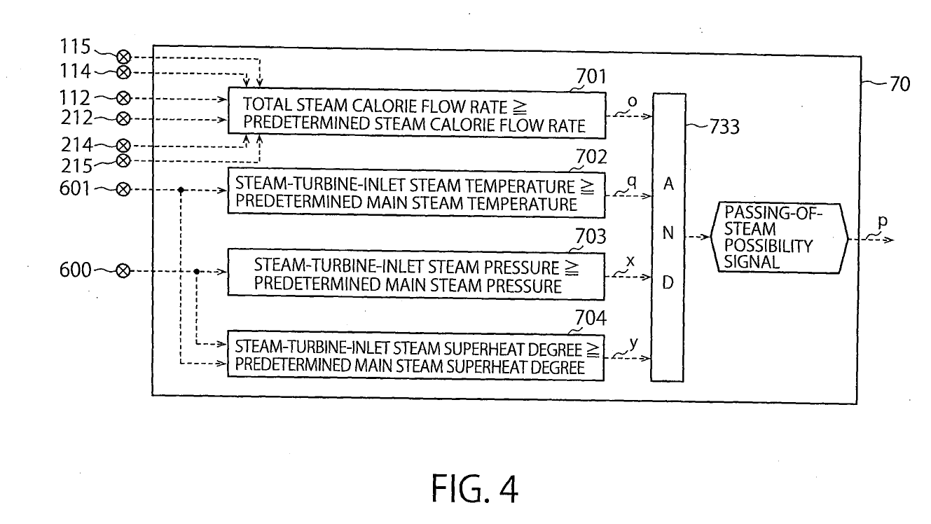

Next, the configuration of the passing-of-steam possibility determining unit 70 will be described, using FIG. 4. Generally, the passing of steam to the steam turbine 402 is not performed at a certain fixed steam temperature and steam flow rate, and the values of the steam temperature and steam flow rate vary depending on the remaining heat condition of the plant at the time of the starting, and the like. The determination of whether the passing of steam is possible is the determination of whether the steam turbine 402 can be driven in a particular operation state (for example, a no-load rated-speed operation) by the generated steam at that time. Therefore, for example, in the case where the steam temperature is relatively high, the passing of steam is possible even when the steam flow rate is low, and in the case where the steam temperature is low, a high steam flow rate is required. For comprehensively determining these, FIG. 4 is an example in which the calorie flow rate is determined and the passing-of-steam possibility signal “p” is generated and in which the total value of the calorie flow rate of the steam generated by the #1 unit and the calorie flow rate of the steam generated by the #2 unit is calculated and the passing-of-steam possibility signal “p” is generated.

FIG. 4 is a schematic block diagram of the passing-of-steam possibility determining unit 70 according to the embodiment.

The passing-of-steam possibility determining unit 70 includes a first arithmetic comparator 701, a first comparator 702, a second comparator 703, a second arithmetic comparator 704, and an AND gate (generating unit) 733.

As described above, the measured values of the pressure (the pressure sensor 112, the pressure sensor 212 and the pressure sensor 600), temperature (the temperature sensor 114, the temperature sensor 214 and the temperature sensor 601), and flow rate (the flow rate sensor 115 and the flow rate sensor 215) of the steam, which are necessary for computation, are input from the #1 unit and #2 unit to the controlling apparatus 300, and necessary measured values are input to the arithmetic comparators and comparators for generating the passing-of-steam possibility signal “p”, respectively.

In the first arithmetic comparator 701, a first input is connected with the pressure sensor 112, and a second input is connected with the pressure sensor 212. The first arithmetic comparator 701 sums the calorie flow rates of the steam generated from the above plurality of drums, that is, the #1 drum 113 and the #2 drum 213, and compares the sum value obtained by the summation, with a predetermined steam calorie flow rate. Concretely, for example, the first arithmetic comparator 701 calculates the calorie flow rates of the steam in the respective units, and sets a signal “o” to 1 when the sum value is greater than or equal to the predetermined steam calorie flow rate.

Here, the steam calorie flow rate is calculated as the product of the enthalpy “H” of the steam and the mass flow rate “G”. For example, the steam calorie flow rate of the #1 drum 113 is calculated as follows. The first arithmetic comparator 701, for example, calculates the enthalpy from the temperature measured by the temperature sensor 114 and the steam pressure measured by the pressure sensor 112. Further, the first arithmetic comparator 701, for example, calculates the specific gravity from the temperature measured by the temperature sensor 114 and the steam pressure measured by the pressure sensor 112, by an approximate formula of a steam table, and calculates the mass flow rate, based on the calculated specific gravity and the flow rate measured by the flow rate sensor 115. Then, the first arithmetic comparator 701 calculates the product of the calculated enthalpy of the steam and the mass flow rate, as the steam calorie flow rate of the #1 drum 113.

Similarly, the steam calorie flow rate of the #2 drum 213 is calculated as follows. The first arithmetic comparator 701, for example, calculates the enthalpy from the temperature measured by the temperature sensor 214 and the steam pressure measured by the pressure sensor 212. Further, the first arithmetic comparator 701, for example, calculates the specific gravity from the temperature measured by the temperature sensor 214 and the steam pressure measured by the pressure sensor 212, by the approximate formula of the steam table, and calculates the mass flow rate, based on the calculated specific gravity and the flow rate measured by the flow rate sensor 215. Then, the first arithmetic comparator 701 calculates the product of the calculated enthalpy of the steam and the mass flow rate, as the steam calorie flow rate of the #2 drum 213.

The measured steam temperature value by the sensor 601 of the steam header unit 505 is input to the first comparator 702. The first comparator 702 compares the temperature detected in the steam header unit 505, with a predetermined main steam temperature. The first comparator 702 sets a signal “q” to 1, when the measured steam temperature value by the sensor 600 is greater than or equal to the predetermined main steam temperature as a result of the comparison.

The measured steam pressure value by the sensor 600 of the steam header unit 505 is input to the second comparator 703. The second comparator 703 compares the steam pressure detected in the steam header unit 505, with a predetermined main steam pressure. The second comparator 703 sets a signal “x” to 1, when the measured steam pressure value by the sensor 600 is greater than or equal to the predetermined main steam pressure as a result of the comparison in the comparator 703.

The steam pressure by the sensor 600 of the steam header unit 505, and the measured temperature value are input to the second arithmetic comparator 704. The second arithmetic comparator 704 calculates a steam-turbine-inlet steam superheat degree, based on the temperature detected in the steam header unit 505 and the steam pressure detected in the steam header unit, and compares the calculated steam-turbine-inlet steam superheat degree with a predetermined main steam superheat degree. Concretely, for example, the second arithmetic comparator 704 calculates the superheat degree of the steam in the steam header unit 505, with reference to the steam table, and sets a signal “y” to 1 when it is greater than or equal to the predetermined main steam superheat degree. Here, the steam table is a table in which a pressure and a saturation temperature at the pressure are associated. The second arithmetic comparator 704 acquires a saturation temperature corresponding to the measured pressure of the steam header unit 505, with reference to the steam table, and subtracts the saturation temperature from the measured temperature of the steam header unit 505. Thereby, the superheat degree of the steam is calculated.

When all of the above signals “o”, “q”, “x” and “y” become 1, the AND gate 733 turns the passing-of-steam possibility signal “p” ON. Thus, the AND gate 733 generates the passing-of-steam possibility signal “p” indicating whether the passing of steam to the steam turbine 402 is possible, based on the comparison results by the first arithmetic comparator 701, the first comparator 702, the second comparator 703 and the second arithmetic comparator 704.

Thus, in the starting method according to the embodiment, in which the passing of steam is performed with the #1 unit and the #2 unit linked, the passing of steam can be performed by the summation of the calorie flow rates of the steam generated in the two units. Therefore, it is possible to significantly shorten the time for the rise to the steam flow rate at which the passing of steam is possible, compared to the case in which the passing of steam is performed by the calorie flow rate generated in one unit.

Here, the embodiment is an application to two units. However, an N-N-1 combined cycle power plant configured by gas turbines and heat recovering steam generators whose numbers are “N” also can achieve the significant shortening of the starting time, by performing the passing of steam by the summation of the calorie flow rates of the steam generated in the “N” units.

Thus, according to the embodiment, the controlling apparatus controls a combined cycle power plant having at least a plurality of units, each of which includes the gas turbine, the heat recovering steam generator to recover the heat of the exhaust gas from the gas turbine and to generate steam from an incorporated drum, and the turbine bypass regulating valve to send the steam generated from the drum while keeping a predetermined pressure, and including the steam header unit that merges together the steam generated from the plurality of drums, and the steam turbine to which the steam in the steam header unit is supplied.

When the plurality of units are linked, the controlling unit CON controls the plurality of turbine bypass regulating valves, based on the steam pressure detected in the steam header unit 505.

The controlling unit CON includes the common pressure controlling unit 620 to generate the control command value indicating the opening degree of each of the plurality of turbine bypass regulating valves, based on the steam pressure, and controls the plurality of turbine bypass regulating valves, based on the control command value generated by the common pressure controlling unit 620.

Further, for each of the units, the shut-off valve to shut off steam is provided on the pipe through which the steam generated from the drum is sent to the steam header unit 505.

Then, the controlling unit CON further includes the plurality of pressure controlling units (corresponding to the first pressure controlling unit 120 and the second pressure controlling unit 220) each of which is provided for each of the units, and generates the control command value indicating the opening degree of the turbine bypass regulating valve, based on the steam pressure in the drum or the steam pressure at the upstream side of the shut-off valve. Furthermore, the controlling unit CON includes the plurality of switching units (630, 631) each of which is provided for each of the units and switches the control of the turbine bypass regulating valve, depending on the open/closed state of the shut-off valve.

Then, when the shut-off valves are opened, the switching units (630, 631) controls the plurality of turbine bypass regulating valves based on the control command value generated by the common pressure controlling unit 620.

Further, when the shut-off valve is closed, the switching unit (630, 631) controls the corresponding turbine bypass regulating valve based on the control command value generated by the first pressure controlling unit 120 or the second pressure controlling unit 220.

### Effect of the Embodiment

Thereby, in the controlling unit CON according to the embodiment, the common pressure controlling unit 620, which is common among the respective units, performs the branching of the control command value (MV value), and based on this control command value, performs the pressure controls of all the turbine bypass regulating valves of the respective units. Therefore, the problem of the interference of the pressure controls of the turbine bypass regulating valves is removed, and it is possible to perform the passing of steam to the steam turbine, with the respective units linked, and to shorten the starting time.

Further, in the starting with the respective units linked, the passing-of-steam possibility determining unit 70 determines whether the passing of steam to the steam turbine 402 is possible, based on the total value of the calorie flow rates of the steam generated in the respective units. Therefore, compared to the case in which the passing of steam is performed by the steam flow rate generated in one unit, the time required for the establishment of the steam flow rate at which the passing of steam is possible is reduced, and the starting time is shortened.

Further, in the above description, the example of using a PID controller, which is the most common controller, has been described. However, it is known that an LQR, a GPC and the like have a similar feedback control function, and the present invention can be applied even when these controllers having the equivalent function are used.

Further, the embodiment has described that the constant value (7.0 MPa) and the MV value (setting value: 0%) for fully closing the turbine bypass regulating valves are used as the pressure setting value (SV value). A technique in which the PV value and the SV value do not deviate from each other has been proposed. Naturally, the controlling apparatus 300 according to the embodiment can perform the control, in combination with this technique, and the combination with the technique in Patent Literature 3 does not reduce the usefulness of the controlling apparatus 300 according to the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A controlling apparatus to control a combined cycle power plant that includes at least a plurality of units, each of the units including a gas turbine; an heat recovering steam generator that recovers heat of exhaust gas from the gas turbine and generates steam from an incorporated drum; and a turbine bypass regulating valve that sends the steam generated from the drum while keeping a predetermined pressure, and comprises a steam header unit that merges together the steam generated from a plurality of the drums; and a steam turbine to which the steam in the steam header unit is supplied,
the controlling apparatus comprising a controlling unit that controls a plurality of the turbine bypass regulating valves based on a steam pressure detected in the steam header unit when the plurality of the units are linked.

2. The controlling apparatus according to claim 1,
wherein the controlling unit
comprises a common pressure controlling unit that generates a control command value indicating an opening degree of each of the plurality of the turbine bypass regulating valves based on the steam pressure, and
controls the plurality of the turbine bypass regulating valves based on the control command value generated by the common pressure controlling unit.

3. The controlling apparatus according to claim 2,
wherein for each of the units, a shut-off valve to shut off the steam is provided on a pipe through which the steam generated from the drum is sent to the steam header unit,
the controlling unit further comprises:
a plurality of pressure controlling units each of which is provided for each of the units and generates the control command value indicating the opening degree of the turbine bypass regulating valve based on a steam pressure in the drum or a stream pressure at an upstream side of the shut-off valve; and
a plurality of switching units each of which is provided for each of the units and switches control over the turbine bypass regulating valve, depending on an open/closed state of the shut-off valve,
the switching units control the plurality of the turbine bypass regulating valves, respectively based on the control command value generated by the common pressure controlling unit when the shut-off valves are open, and
the switching units control the corresponding turbine bypass regulating valves based on the control command values generated by the pressure controlling units, respectively when the shut-off valves are closed.

4. The controlling apparatus according to claim 2
wherein the controlling unit begins starting of the gas turbine in a state in which the shut-off valve is closed, determines that at least one of a pressure, a temperature and a flow rate of the steam generated from the drum of the heat recovering steam generator is equal to that of the heat recovering steam generator of the precedently started gas turbine, and executes a process of opening the shut-off valve, and
in a state in which all of the plurality of the shut-off valves are opened and the plurality of the turbine bypass regulating valves are controlled by the common pressure controlling unit, the controlling unit closes the plurality of the turbine bypass regulating valves simultaneously and gradually, merges together all of the steam generated from the plurality of the drums in the steam header unit, and performs passing of steam to the steam turbine.

5. The controlling apparatus according to claim 3, comprising a control switching unit that switches the control over the plurality of the turbine bypass regulating valves between a control by forcible valve closing and a control by the common pressure controlling unit, based on a steam pressure and a temperature of the steam header unit as well as a pressure of each of the drums included in the respective units when the switching units control the plurality of the turbine bypass regulating valves based on the control command value generated by the common pressure controlling unit.

6. The controlling apparatus according to claim 5,
wherein the control switching unit comprises:
a passing-of-steam possibility determining unit that determines whether passing of steam to the steam turbine is possible based on at least a total value of calorie flow rates of the steam generated in the respective units; and
a plurality of switching units each of which is provided for each of the units and switches between the control by the forcible valve closing and the control by the common pressure controlling unit based on a result of determination of the passing-of-steam possibility determining unit.

7. The controlling apparatus according to claim 6,
wherein the passing-of-steam possibility determining unit comprises:
a first arithmetic comparator that sums up the calorie flow rates of the stream generated from the plurality of the drums, and compares a sum value obtained by summation with a predetermined steam calorie flow rate;
a first comparator that compares a temperature detected in the steam header unit with a predetermined main steam temperature;
a second comparator that compares a steam pressure detected in the steam header unit with the predetermined main steam pressure;
a second arithmetic comparator that calculates a steam-turbine-inlet steam superheat degree based on the temperature detected in the steam header unit and the steam pressure detected in the steam header unit, and compares the calculated steam-turbine-inlet steam superheat degree with a predetermined main steam superheat degree; and
a generating unit that generates a passing-of-steam possibility signal based on comparison results of the first arithmetic comparator, the first comparator, the second comparator and the second arithmetic comparator, the passing-of-steam possibility signal indicating whether the passing of steam to the steam turbine is possible.

8. A starting method of starting a combined cycle power plant that includes at least a plurality of units, each of the units including a gas turbine; an heat recovering steam generator that recovers heat of exhaust gas from the gas turbine and generates steam from an incorporated drum; and a turbine bypass regulating valve that sends the steam generated from the drum while keeping a predetermined pressure, and comprises a steam header unit that merges together the steam generated from a plurality of the drums; and a steam turbine to which the steam in the steam header unit is supplied,
the starting method comprising controlling a plurality of the turbine bypass regulating valves based on a steam pressure detected in the steam header unit when the plurality of the units are linked.
